(19) United States
(12) Patent Application Publication
(10) Pub. No.: US 2025/0261654 A1
(43) Pub. Date: Aug. 21, 2025

(54) Batter Compositions, Packaged Batter Products, and Related Methods

(71) Applicant: General Mills, Inc., Minneapolis, MN (US)

(72) Inventors: Susan Yvonne deWerff, Minnetonka, MN (US); Samuel Emerson, Minneapolis, MN (US); Lauren Gillman, St. Paul, MN (US); Charles Stephen Lucas, Minneapolis, MN (US); Kenneth Eugene Smith, North Oaks, MN (US); Michelle Tollefson, Lakeville, MN (US)

(73) Assignee: General Mills, Inc., Minneapolis, MN (US)

(21) Appl. No.: 18/582,140

(22) Filed: Feb. 20, 2024

(51) Int. Cl. A21D 10/04; A21D 2/36; A23L 29/30

(52) U.S. Cl. CPC A21D 10/045; A21D 2/36; A23L 29/30

(57) ABSTRACT

Described are packaged batter compositions, and related methods, the batter compositions being refrigerator stable in a non-pressurized package. The compositions include a fruit and/or vegetable puree and are suitable for making quick bread and/or muffins. The compositions preferably exclude gums and/or hydrocolloids.

### FIELD OF THE INVENTION

The invention relates to fruit or vegetable-containing batter compositions, packaged batter compositions, and related methods, the batters being refrigerator stable.

### BACKGROUND

Quick breads and muffins, such as banana, pumpkin, and apple breads and muffins, are often made from scratch by which a consumer makes a batter by combining a fruit and/or vegetable puree with other wet ingredients and dry ingredients. The batter is then cooked soon after mixing. While these methods produce high quality baked goods, preparing the batter from scratch can be time consuming and messy. Also, the batter that is prepared can be used by the consumer for only a short time. The batters are not typically microbiologically stable if refrigerated unless they have been pasteurized, inerted, or stored under pressure; if not used immediately the batter will not produce a cooked product having optimum leavening action; and the batter will typically phase separate after a relatively short period. In addition, the batter will typically have a high water activity, making it susceptible to microbial growth.

### SUMMARY

Described herein are practical ready-to-use packaged batter products, embodiments of which can exhibit refrigerated storage stability after initial preparation, during transportation, storage, and sale to a consumer. The packaged product may be stable during refrigerated storage for many weeks after the packaged batter product is initially prepared (filled and sealed), such as for a period during which the initially filled and sealed packaged batter product is transported for sale, presented for sale and sold to a consumer, and then stored by the consumer with refrigeration before an initial opening and use by the consumer.

Storage stability can desirably include some or all of: freshness of the batter during refrigerated storage as measured by coloration, flavor, physical stability (not phase separating during storage; desired rheology such as yield point and flowability), organoleptic properties, cooking properties (i.e., leavening), and resistance to microbial growth; preferred batters throughout extended refrigerated storage periods may be capable of being cooked to exhibit taste, aroma, leavening, texture, coloration, etc., on par with a batter that is freshly made from scratch.

As a specific measure of refrigerated stability, certain preferred packaged batter products exhibit desirable and consistent rheology properties during a refrigerated storage period. For example, preferred batters can exhibit a yield point value (a.k.a. yield strength) that is similar to a freshly prepared batter of a similar product type (e.g., biscuits, muffins, cakes, brownies, waffle, crepe, etc.), e.g., will readily spread in a cooking container and will otherwise cook and perform in a fashion comparable to a freshly prepared batter.

Batter compositions, to achieve these desired physical, performance, and stability properties, can be formulated to exhibit a reduced water activity, can be prepared to form a stable emulsion, and can include an oxidoreductase enzyme. Desirably and advantageously, it has been discovered that certain combinations of ingredients can be included in a batter to also retain desired rheology, and to provide storage stability such as allowing the package to be opened and re-sealed, then refrigerated without the package collapsing ballooning. Certain preferred batters can simultaneously exhibit a combination 1) a low aw value (not in excess of 0.85), to effect microbial stability, and 2) a rheology enabling the batter to flow readily upon application (looks and performs more similarly to a much higher aw freshly prepare batter products). Furthermore, this unique low aw and low yield point batter system is accomplished preferably without a hydrocolloid or gum ingredient.

Batters as described can include ingredients such as a fruit and/or vegetable puree, flour, water, chemical leavening agent (e.g., sodium bicarbonate), sugar, non-sugar water-activity reducing agent (e.g., glycerin), and fat. To achieve storage stability in combination with desired final (cooked) product properties, the batter can optionally include additional ingredients such as one or more of oxidoreductase enzyme, antimicrobial agent (e.g., natural antimicrobial agent), and emulsifier. Preferred batter formulations include ingredients such as these in amounts to prepare a ready-to-use, pre-mixed refrigerated packaged batter product that is physically and microbiologically stable for a refrigerated storage period as described herein (e.g., up to 120 days), and that exhibits rheological and cooking properties similar to a freshly prepared batter (e.g., from scratch) during such a refrigerated storage period.

Embodiments of batters as described herein can be sold commercially as packaged, ready-to-use batters, e.g., quick bread batters. These batters can exhibit shelf stability that allows refrigerated storage (e.g., at 40° F.) of the packaged batter product for many weeks. The batter, during the refrigerated storage period (after being first opened), is capable of being cooked to a cooked product that has taste, aroma, texture, leavening (i.e., baked volume), coloration, etc., on par with a batter freshly made from scratch just after preparation. Herein, the term “baked volume” or “baked specific volume” refers to volume or specific volume of a cooked (e.g., baked or fried) product.

According to certain embodiments of the packaged batter product, the packaged product can be stored in an initially filled and sealed condition at a refrigerated condition (e.g., from 38 to 45 degrees Fahrenheit) for an extended period, such as for a refrigerated storage period of at least 2, 4, 6, 8, 10, 12, or more weeks at a refrigerated temperature. The packaged product is sufficiently stable that the product can be prepared commercially, transported, stored, and sold as a consumer food product, and specifically can retain desired properties as described herein, such as desired rheology, bake properties, emulsion stability, and package dimensions, during such a refrigerated storage period.

### BRIEF DESCRIPTION OF THE DRAWINGS

FIG. 1 is a set of photos comparing cooked product made from batters from Table 1 (banana batter) and Table 2. The top photos show product cross section; the bottom photos show a top view of uncut product.

FIG. 2 is a set of photos comparing uncooked batters made according to Table 1 (banana batter), Table 2 (V4), and Table 3.

FIG. 3 is a set of photos comparing cooked product made from the batters from FIG. 2.

FIG. 4 is a set of photos comparing cooked product made from the batters from FIG. 2. The top photos show product cross section; the bottom photos show a top view of uncut product.

### DETAILED DESCRIPTION

Described are ready-to-use, pre-mixed and pre-made packaged batter products having refrigerated storage stability. The packaged product may be stable during refrigerated storage (e.g., at about 40° F.) for many weeks (e.g., about 90 to about 120 days, or about 100 to about 120 days) after the packaged batter product is prepared, initially placed in a package, and the package is sealed (i.e., the package is “initially filled and sealed”). For example, the packaged product (after initially being filled and sealed and before being first opened by a consumer, at which time air will be introduced into the package) may exhibit refrigerated storage stability for a period of up to 120 days, during which the initially filled and sealed packaged batter product may be transported for sale, presented for sale and sold to a consumer, and then stored by the consumer with refrigeration.

Refrigerated stability means that a batter of a ready-to-use packaged batter product can appear and perform in a manner that is comparable to a freshly made batter product of a similar type, and can be physically and microbiologically stable for lengthy (e.g., up to or in excess of 12 weeks) refrigerated storage periods. The batter can exhibit a stable physical form in the form of an emulsion (which specifically also includes a batter considered to be stable suspension) that does not phase separate or coalesce during the refrigerated storage period. Additionally or alternately, the batter can exhibit stable rheology as described herein by maintaining a desirably low yield point during extended refrigerated storage. Additionally or alternately the batter can exhibit desired cooking performance, such as the ability to be cooked to a desired baked specific volume of a quick bread or muffin, as described herein. And the batter should exhibit otherwise acceptable flavor, aroma, texture, and look of an uncooked and cooked batter product. The package of the refrigerator stable packaged products can exhibit dimensional stability, including that the package does not experience undue expansion or collapse due to changes in the chemical makeup or changes in the gaseous composition of the batter product during a refrigerated storage period.

The term “batter” is used in a manner consistent with its meaning in the cooking and food technology arts to refer to a raw (uncooked), food product that is leavenable (“leavened”) by chemical leavening agents, is less viscous than a “dough” (e.g., a bread or a cookie dough), and has a higher water content than a dough. Quick bread, muffin, pancake, waffle, crepe, and cake batter are examples of types of batters, as compared to dough.

Preferred batters as described can be capable of being squeezed or ladled into a cooking container (e.g., a bread pan or a muffin tin, or the like), such as is typical of a quick bread or muffin batter. According to packaged batter products as described, the batters can be squeezed or ladled into a cooking container. To be capable of being squeezed from a container into a cooking container, a batter can exhibit rheological properties that allows squeezing from a package, e.g., can exhibit a yield point that is below a maximum yield point level at which squeezing is no longer possible. Upon depositing into a cooking container, the batter must spread to a desired dimension to yield a cooked product of desired size, for example, to at least partially fill the cooking container.

Exemplary batters can also exhibit a relatively lower water activity level compared to some other batter compositions, including quick bread batters freshly made from scratch, which generally exhibit a water activity in a range above about 0.94. A relatively low water activity reduces potential microbial activity within a refrigerated batter and improves refrigerated storage stability. In general, a batter as described can have a water activity of about 0.85 or lower, e.g., about 0.83 to about 0.85. If the water activity is higher, microbial stability over extended time periods may be reduced. If the water activity is lower, microbial stability under refrigeration temperatures may be satisfactory, but the amount of available water may be so low that the resulting cooked batter product may not have a high volume and fluffy texture and may be unacceptably dry.

Water activity (aw) refers to the amount of water in a food product (such as a batter) that is available to microorganisms. Water activity is a measure of how efficiently a portion of the total amount of water present in a food product can take part in a chemical (physical) reaction, and is sometimes considered to measure the “free,” “unbound,” or “available” water in a system. Water that is tightly bound or tightly associated with a chemical constituent of a food composition, e.g., is tightly bound to a protein molecule, is not available for alternate use, is not “free” or “available” water. Water activity refers to the amount of water in a food or beverage that is not so tightly bound that the water is unavailable. Water activity (a_{w}) is defined as:

a_{w}=P/Pₒ

where P and Pₒ are the partial pressure of water above the food, and the partial pressure of water at identical conditions, respectively. Any tightly bound water does not escape from the food as a vapor, and therefore exerts no partial pressure and has an effective water activity of zero. Water activity is a function of the composition of a food product, and is also a function of temperature.

Batters as described herein contain fruit and/or vegetable puree, flour, sugar, fat, glycerin, and a chemical leavening agent (e.g., a leavening base). Batters described here are suitable for being cooked (e.g., baked) to produce quick bread and/or muffins, such as banana, pumpkin, or apple bread or muffins.

A fruit and/or vegetable puree is included in an amount of about 20% to about 30% (e.g., about 22% to about 28%) by weight of a batter. A fruit and/or vegetable puree contributes to the flavor, texture, appearance, and structure of a batter. Suitable purees can include, for example, banana puree, apple puree, squash puree (e.g., butternut, pumpkin, zucchini, and the like), carrot, and the like. In some embodiments, a puree from one fruit and/or vegetable can be combined with another puree, or combined with fruit pieces, powders, and/or juice from the same or a different fruit and/or vegetable, to achieve a desired flavor profile. For example, an apple puree can be combined with pumpkin flakes to achieve a flavor profile suitable for a pumpkin bread or muffin.

Fruit and/or vegetable puree also contributes a significant amount of water to a batter. Depending on the moisture content of the fruit and/or vegetable puree (typically, about 70% to about 92% by weight of the puree) and taking into consideration the moisture content of other ingredients included in a puree provided herein, water can be added to achieve a final moisture content of about 20% to about 28% by weight of the batter.

A flour component contributes to the structure of the batter. A variety of different flours may be used, and different flours can be selected to give a variety of textures, tastes, and appearances to the final cooked batter product. Useful flours include hard wheat flour, soft wheat flour, corn flour, high amylose flour, and low amylose flour. A single flour type may be useful, or a combination, with the relative proportions of types of flours being varied as desired. Batters as described herein can include from about 25% to about 30% flour (e.g., from about 25 to about 28) by weight of the batter.

Flour may be natural flour (directly derived from a grain). The flour may alternately be what is sometimes referred to as an “artificial” flour, which is a combination of natural flour constituents provided, for example, by a combination separated concentrated protein and starch ingredients. See patent document WO 2007/130070. According to preferred batter composition, a natural flour is used in a batter, as opposed to an “artificial” flour.

Added sugar can be included in a batter composition to provide sweetness, to alter browning, to alter texture, to lower the water activity of the batter, or for any of these purposes. As used herein, the term “added sugar” refers to a sugar that is concentrated or refined from a sugar source, such as table sugar (i.e., sucrose) or syrups. Sugars of any type and size (e.g., molecular weight) can be useful in a batter. However, a batter as described can preferably include sugars that exhibit a comparatively lower molecular weight such as small mono-, and di-saccharides (sucrose, fructose), as opposed to sugars having a comparably higher molecular weight, e.g., maltodextrins and corn syrup solids. In some embodiments, a batter can include an added sugar that consumers recognize as being readily available in a home pantry, such as sucrose, honey, or maple syrup. In some embodiments, a non-reducing sugar (e.g., sucrose) can be selected as an added sugar to reduce browning during cooking. In some embodiments, a batter can exclude high fructose corn syrup.

An added sugar can be included in an amount of about 20% to about 30% (e.g., about 22% to about 30%) by weight of a batter. It is to be understood that the amount of total sugar in a batter includes added sugar, as well as sugar from other ingredients, such as the fruit and/or vegetable puree. Total sugar content of a batter can be from about 28% to about 32% by weight of the batter.

In addition to sugar as a water-activity reducing agent, other water-activity reducing agents can be used in an amount to reduce water activity without increasing sweetness (referred to herein as “non-sugar water activity reducing agents”). For example, a polyhydric alcohol such as glycerol (glycerin) can be included in an amount of about 2% to about 6% (e.g., about 3% to about 5%) by weight of a batter. Optionally, instead of or in addition to glycerol, other non-sugar water activity reducing agents can be included in a batter, such as sorbitol.

A batter also includes fat in an amount of about 8% to about 20% (e.g., about 10% to about 18%) by weight of the batter. The fat can contribute to the volume, grain, and texture of the uncooked batter product, as well as the texture, mouthfeel and other organoleptic properties of the cooked batter. Suitable fats can be solid or liquid at room temperature, and can include vegetable- and/or animal-based fats. Examples of suitable fats include fats, oils, fat fractions and/or shortenings derived from palm oil, palm kernel oil, soybean oil, lard, algae oil, butter, canola oil, corn oil, peanut oil, coconut oil, and the like, or any combination thereof. These oils can be used alone or in combination as the oil component of a batter. In some embodiments, a batter can include palm- and/or canola-based fat, such as a shortening and/or flaked fat. In some embodiments, an included fat can have a Mettler Dropping Point (MDP) of from about 100° F. to about 140° F.

A batter provided herein include a leavening base, such as sodium bicarbonate, in an amount sufficient to ensure leavening of the batter while cooking. A leavening base can be included in an amount of about 0.01% to about 2% (e.g., about 0.05% to about 1.5%, or about 0.05% to about 0.5%) by weight of the batter. Although a leavening acid may also be included, a fruit puree can, in many cases, provide enough acidity for the leavening base to create a leavening reaction during baking.

In some embodiments, a batter provided herein can include an egg ingredient, such as a liquid or powdered egg ingredient (e.g., whole, white, yolk, or any combination thereof). An egg ingredient can be included in an amount sufficient to contribute a solids content of about 1% to about 5% (e.g., about 1% to about 3%) by weight of the batter. Egg can contribute structure to a baked good made from a batter provided herein.

In some embodiments, a batter can include other ingredients, such as flavorants (e.g., vanilla, chocolate flavoring, almond extract, fruit and/or vegetable juice, and the like), colorants (e.g., fruit juices, natural and artificial colors, and the like), spices (e.g., cinnamon, nutmeg, and the like), antimicrobial agents (e.g., nisin, propionate, sorbate, and the like), starch (e.g., unmodified, pregelatinized, modified, and the like), and the like. For example, a starch (e.g., a pregelatinized starch) can be included in an amount of up to 2% by weight of a batter. In some embodiments, other ingredients can be included in a total amount of up to 10% (e.g., up to 8%, or up to 5%) by weight of a batter. In some embodiments, a batter provided herein can exclude certain ingredients, such as gums, hydrocolloids, emulsifiers (other than egg), and/or preservatives. As used herein, the term “other ingredient” refers to any ingredient other than fruit and/or vegetable puree, flour, sugar, fat, non-sugar water activity reducing agents, leavening base, and water.

A batter described herein is a continuous phase. Surprisingly, a batter described herein remains a continuous phase (i.e., does not appreciably separate) over the refrigerated shelf life of the packaged product, even in the absence of certain ingredients such as gums, hydrocolloids, and emulsifiers other than egg. Thus, a consumer need not stir or mix the batter before transferring the batter to a cooking container and cooking the batter to produce a quick bread or muffin.

In some embodiments, a batter can also include particulates within the continuous phase of the batter. For example, dried fruit, chocolate chips, nuts, and the like can be included in a batter. In some embodiments, if particulates are included in a batter, they can be suspended throughout the batter such that the particulates are relatively evenly distributed in the final cooked product without requiring a consumer to mix or stir the batter to distribute them. Alternatively, particulates can settle in a batter, which can either be stirred by the consumer or produce a cooked product with a layer of particulates (e.g., nuts on the top, or fruit on the bottom). In some embodiments, particulates can be separately added to a batter or finished cooked product by the consumer. It is to be understood that particulates do not constitute an “other ingredient” for the purposes of formulation of a batter described above. Thus, particulates can be included in any appropriate amount up to about 20% (e.g., about 15%) by weight of a batter.

A batter can be prepared by any useful method and manufacturing equipment. Generally, ingredients of a batter are mixed together to form the batter. In some embodiments, some or all of the ingredients of a batter can be kept cool (e.g., at 50° F. or cooler) prior to and/or during production of the batter. A longer mixing time during formation of a batter can increase the likelihood of the leavening base reacting to produce carbon dioxide. Thus, in some embodiments, it is preferred that the amount of mixing time be not significantly longer than needed to ensure that the ingredients are mixed to form a batter. Ingredients for a batter can be combined in any order. In some embodiments, it is useful to follow an order of addition of ingredients that are similar to other products made using a production line. For example, on a production line that also makes cookie dough, it can be useful to combine the added sugar and fat, then add the fruit and/or vegetable puree, glycerin, and water, and then add the remaining ingredients to produce a batter. In some embodiments, a batter can be packaged shortly after being made (e.g., within 4 hours or within 1 hour) to reduce the amount of time that the leavening base can react before packaging and/or to reduce exposure to oxygen.

A batter can be particularly useful when contained in a dispensing container or package, such as a plastic chub, pouch, plastic tub, or plastic pail. Preferably, a package or container allows a consumer to squeeze the batter out of the package into a cooking container. In some embodiments, a package can be resealable and/or partitioned to allow a consumer to use a portion of the batter at a time. For example, a batter can be contained in a package that is portioned into muffin-sized portions to assist a consumer in portioning the batter into a muffin tin for cooking. In some embodiments, a package can also be suitably sized to contain sufficient batter for common cooking pan sizes, such as a 9 inch×5 inch bread pan, an 8 inch×8 inch brownie pan, a 5 inch×3 inch mini loaf pan, a 12 cup muffin pan, or a 9 inch round springform pan.

Certain preferred embodiments of packaged batter products include batter in a squeeze container or squeeze package that includes resilient (squeezable) sidewalls and an opening through which batter can be expelled from the interior volume by squeezing the sidewalls.

A packaged batter product can be prepared by any useful method of adding batter to a package (e.g., a plastic chub), and sealing the container. This package, upon being initially filled and initially sealed, can be referred to as an “initially filled sealed package,” meaning the package is filled by way of a commercial production process to contain an initial amount of batter, and is then sealed by placing a re-sealable closure on the filled container. In some embodiments, headspace in the package can be limited to allow any headspace to be filled with carbon dioxide as some of the leavening base reacts in the batter. Carbon dioxide from a partial leavening reaction can displace oxygen in a package, which can reduce oxidation of a batter during shelf life and reduce color change of the batter over shelf life. Carbon dioxide from a partial leavening reaction can also limit the amount of leavening that happens in the package and ensure that some of the leavening base remains for leavening during baking at the end of shelf life. In some embodiments, a headspace can be filled with carbon dioxide or nitrogen during the filling of the packaging with batter rather than relying on a leavening reaction from the batter, but this is not required.

In some embodiments, batters as described do not require and can specifically exclude any form of anti-microbial temperature (heat or cold), pressure, or irradiation treatment during any stage of manufacture or storage, capable of killing or inactivating biologically active organisms or biologically active compounds such as microbes, bacteria, fungus, spores, yeast, mold, etc. Many forms of heat treatment, cold, pressure, and vacuum treatments, are used to improve storage stability of food products by destroying microorganisms, destroying or inactivating spores, or destroying or inactivating otherwise potentially undesirable biologically active materials such as active enzymes, yeasts, proteins, etc. The present methods and batter products advantageously do not require and can specifically exclude any step of exposing a batter or batter ingredient to such high pressure processing to control microbial activity. The present methods and batter products do not require and can specifically exclude any step of exposing a batter, batter ingredient, or packaged batter product to such high temperature (e.g., greater than 60 C, or greater than 100 C) processing in a manner and for a period of time that would allow the batter do achieve that temperature and cause inactivation of microorganisms (e.g., bacteria, fungus, spores, yeast, mold) in the batter. The present methods, batter, and packaged batter products also do not require and can specifically exclude the presence of a concentrated inert gas atmosphere, with low oxygen content, in a package headspace to prolong storage stability. The present methods, batter, and packaged batter products also do not require and can specifically exclude the use of temperatures at or below freezing, however, freezing can be used to extend shelf life of the product by an additional 30 days or more by the manufacturer, retail sale point, or consumer, and can optionally be used during transit. Advantageously, freezing and thawing of a batter provided herein does not substantially affect its functionality or eating attributes. None of the above treatments is necessary, and all can be specifically excluded from preferred embodiments of batters and packaged batter products as described. The present batter products are not required to include any such processing applied to any ingredient (e.g., flour) thereof, to the prepared batter composition itself, or to the prepared batter composition within a package.

Regarding pressure conditions of the batter and packaged batter product, the batter does not require a pressurized atmosphere or pressurization of the interior of the packaged batter product, e.g., to inhibit or prevent microbial growth. A pressurized container is considered to be a container that is closed and sealed to contain a pressure greater than ambient, e.g., greater than about 1 atmosphere (absolute); preferred containers of this description are non-pressurized, and the interior space and contents during use and manufacture are periodically exposed to ambient (atmospheric) conditions. The batter and packaged batter products can be prepared, filled, processed, stored, transported, and used and stored (with refrigeration) by a consumer, entirely at ambient (e.g., atmospheric) pressure.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

The following examples are illustrative and non-limiting.

### EXAMPLES

Three batters were prepared according to Table 1.

TABLE 1

| | | Apple cinnamon | |
|---|---|---|---|
| Ingredient | Banana batter | batter | Pumpkin batter |
| Puree | 22-26% banana puree | 20-25% apple puree | 20-25% apple puree |
| | (74% moisture) | (89% moisture) | (89% moisture) |
| Flour (wheat) | 25-28% | 25-28% | 25-28% |
| Sugar (sucrose) | 24-26% | 24-26% | 26-30% |
| Vegetable shortening | 10-14% | 10-14% | 10-14% |
| (MDP 110-115° F.) | | | |
| Glycerin | 3-4% | 4-5% | 3.5-4.5% |
| Whole dried egg | 1-2.5% | 1.5-3% | 1.5-3% |
| Sodium bicarbonate | 0.1-0.5% | 0.1-0.5% | 0.1-0.5% |
| Water | Added to total | Added to total | Added to total |
| | moisture of 24-26% | moisture of 24-26% | moisture of 24-26% |
| Other ingredients | 2-4% (salt, flavors) | 4-5% (cinnamon, | 4.5-6% (pumpkin |
| | | starch, | flakes, pumpkin |
| | | flavors, salt) | spice, salt, starch, |
| | | | flavors, colors) |
| Particulates | 0% | 4-6% | 0% |

The ingredients were formed into a batter as follows:

Sugar and shortening were creamed together briefly, followed by addition and mixing of puree, glycerin, and any water. All other ingredients were then mixed in at low speed to incorporate the ingredients and produce a homogenous batter.

The batter was ready-to-use refrigerated batter and was stable at 40° F. for at least 100 days in a plastic chub. All three batters could be baked to produce quick bread and muffins that had an eating experience and overall visual appearance very similar to quick breads and muffins made from scratch using a fruit and/or vegetable puree.

The banana batter was baked and compared to a formulation from U.S. Pat. No. 6,217,929 ('929 patent), which did not disclose the inclusion of a fruit and/or vegetable puree, but was also designed to be a ready-to-use refrigerated batter. All of the batters had a water activity between 0.84 and 0.87 after 24 hours at 40° C. The pH of the banana batter from Table 1 was about 6.1, while the batters in Table 2 were between 5.2 and 5.6. 850 g of each batter was placed in a 9 inch×5 inch bread pan and baked at 350° F. until visually done (about 65 minutes for the banana batter from Table 1, and about 55 minutes for the ‘929 samples). The same banana puree was used for each of the appropriate samples. Table 2 shows formulations derived from the '929 patent that were used to compare to the presently described batters.

TABLE 2

| | | | | ′929 (from Ex. 3 |
|---|---|---|---|---|
| | | | ′929 V3 | of ′929) V4 with |
| | ′929 V1 (from | ′929 V2 (from | (from Ex. 3 of | banana puree |
| Ingredient | Ex. 1 of ′929) | Ex. 3 of ′929) | ′929) | added |
| Puree | 0% | 0% | 0% | 6.5% banana |
| | | | | puree (74% |
| | | | | moisture) |
| Flour (wheat) | 27.5% | 27.5% | 27.5% | 22.5% |
| Sugar (sucrose) | 30.7% | 22% | 26.3% | 25.6% |
| Soybean oil | 13.1% | 13.1% | 13.1% | 13% |
| Glycerin | 0% | 5.4% | 2.6 | 4.5% |
| Whole dried egg | 3.5% | 3.5% | 3.5% | 3% |
| ′929 premix | 5.7% | 5.7% | 5.7% | 6.4% |
| Table 2 of ′929 | | | | |
| (includes baking | | | | |
| soda, gums, | | | | |
| emulsifiers, and | | | | |
| other ingredients) | | | | |
| Water | 19.3% | 22.6% | 21% | 17.9% |
| Flavor | 0.22% | 0.22% | 0.22% | 0% |

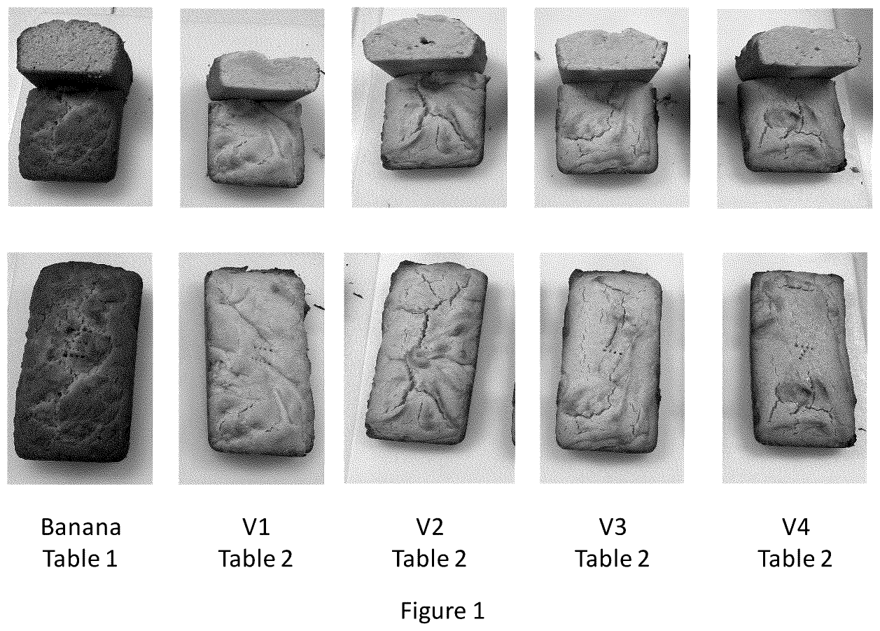

As shown in FIG. 1, the banana batter from Table 1 exhibited a darker color and a bake volume that resembled a made-from-scratch banana bread, while the batters in Table 2 had higher density and lower bake volume. The batters from Table 2 also exhibited a pale color, with the one that contained some banana puree (V4) being slightly darker. The texture and flavor of the banana bread made from the batter in Table 1 closely resembled a made-from-scratch banana bread. In contrast, the texture of the breads made from the batters of Table 2 was dense, with V1 having a gummy interior.

A similar experiment was performed using the banana batter from Table 1, a made-from-scratch recipe adapted from an online website (see, Table 3), V4 from Table 2, and a variation from the '929 patent that contained more banana puree (V5 from Table 3). The same banana puree was used for all batters. The batters were stored for 15 days at 40° C., and then baked in both bread pans (850 g each batter) as described above and in muffin tins (60 g per muffin for each batter).

TABLE 3

| | | ′929 (from Ex. 3 of ′929) |
|---|---|---|
| | | V5 with banana puree |
| Ingredient | Scratch recipe | added |
| Puree | 35.9% banana puree | 24.4% banana puree (74% |
| | (74% moisture) | moisture) |
| Flour (wheat) | 26.3% | 22.5% |
| Sugar (sucrose) | 19.2% | 25.6% |
| Soybean oil | 0% | 13% |
| Butter | 9.8% | 0% |
| Glycerin | 0% | 4.5% |
| Whole dried egg | 0% | 3% |
| Liquid egg | 7.7% | 0% |
| Salt | 0.18% | 0% |
| ′929 premix | 0% | 6.4% |
| Table 2 of ′929 | | |
| (includes baking | | |
| soda, gums, | | |
| emulsifiers, and | | |
| other ingredients) | | |
| Water | 0% | 0% |
| Sodium | 0.38% | (in ′929 premix) |
| bicarbonate | | |
| Flavor | 0.5% | 0.4% |

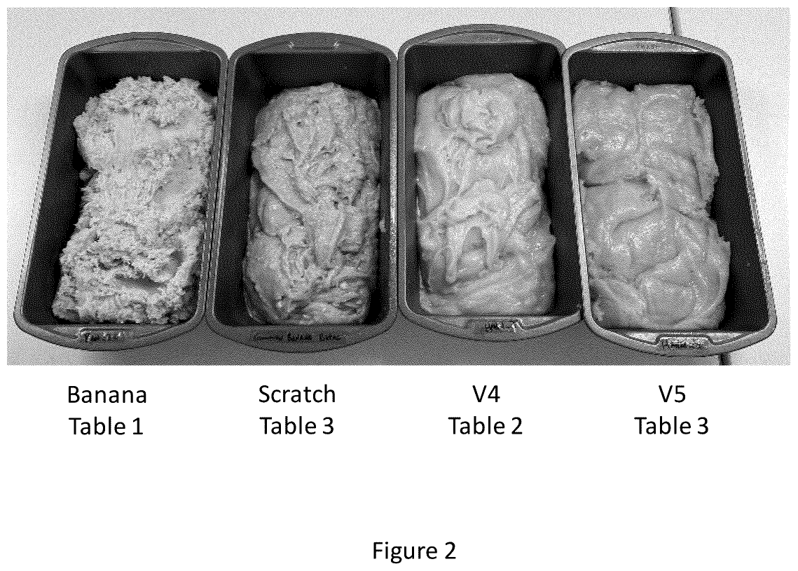

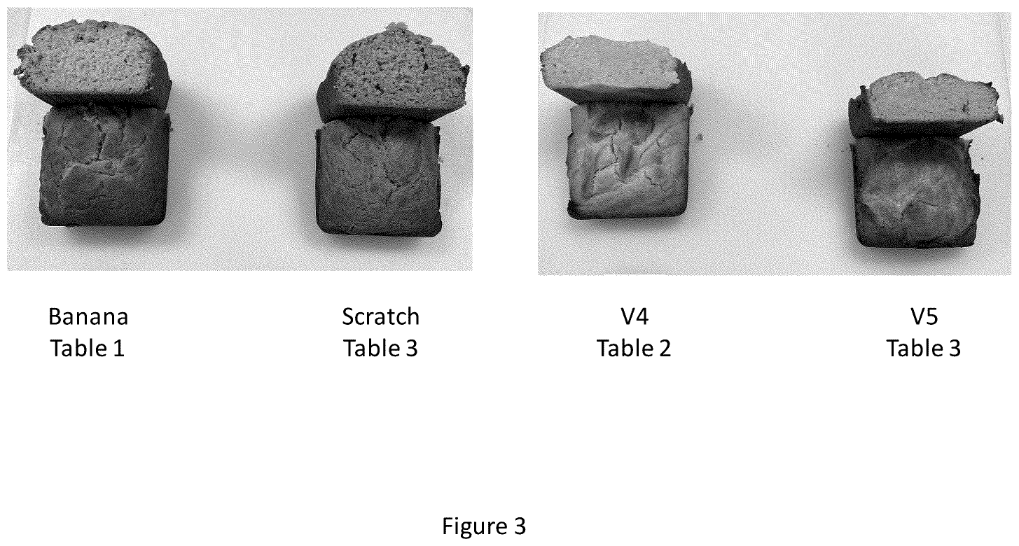

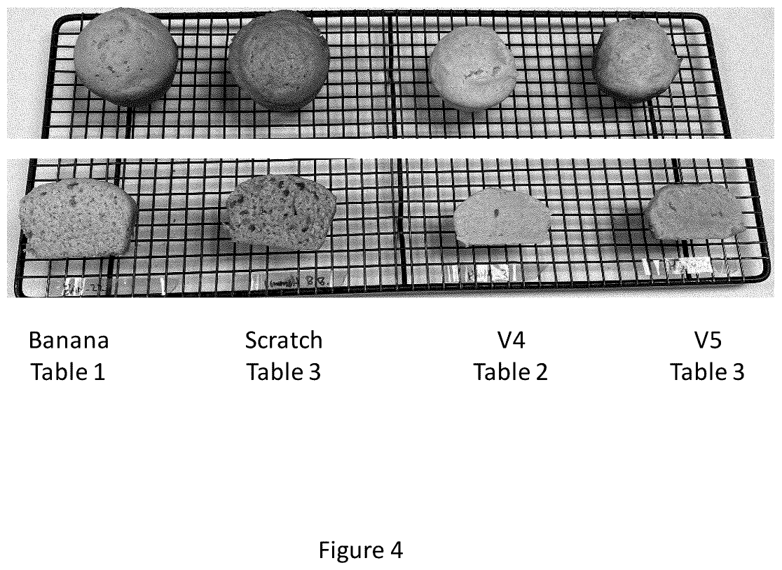

The banana batter from Table 1 exhibited the strongest, cleanest banana flavor with a soft texture, and closely visually resembled the made-from-scratch banana bread. The V4 batter from Table 2 and V5 from Table 3 had higher density and lower bake volume. The V4 batters from Table 2 also exhibited a pale color, as previously observed. The texture and flavor of the banana bread made from the batter in Table 1 closely resembled the made-from-scratch banana bread. However, the made-from-scratch banana bread was beginning to exhibit a grayish color after the 15-day refrigerated storage, and tasted as though it were fermented with a slightly oxidized butter flavor. The texture of the breads made from the batters based on the '929 patent were dense and gummy on the inside. The flavor of the V5 sample was unexpectedly more sour and did not exhibit a more banana flavor than V4. See, FIG. 2 showing uncooked batters, and FIGS. 3 and 4 for cooked product.

What is claimed is:

1. A packaged, refrigerated composition, comprising a batter having a moisture content of about 20% to about 28% by weight and a shelf life at 40° F. of about 90 to about 120 days, the batter including:
a. a fruit or vegetable puree in an amount of about 20% to about 30% by weight of the batter, the fruit or vegetable puree having a moisture content of about 70% to about 92% by weight of the puree;
b. a flour in an amount of about 25% to about 30% by weight of the batter;
c. added sugar in an amount of about 20% to about 30% by weight of the batter, the total sugar content in the batter being about 28% to about 32% by weight of the batter;
d. a fat in an amount of about 8% to about 20% by weight of the batter;
e. glycerin in an amount of about 2% to about 6% by weight of the batter; and
f. a leavening base in an amount of about 0.01% to about 2% by weight of the batter.

2. The packaged, refrigerated composition of claim 1, wherein the fruit or vegetable puree comprises banana puree, apple puree, or squash puree.

3. The packaged, refrigerated composition of claim 1, wherein the fat comprises a Mettler Dropping Point (MDP) of about 100° F. to about 140° F.

4. The packaged, refrigerated composition of claim 1, wherein the batter comprises a starch in an amount of up to 2% by weight of the batter.

5. The packaged, refrigerated composition of claim 4, wherein the starch is a pre-gelatinized starch.

6. The packaged, refrigerated composition of claim 1, wherein the batter comprises an egg ingredient in an amount sufficient to provide a solids content of about 1% to about 5% by weight of the batter.

7. The packaged, refrigerated composition of claim 1, wherein the batter has a moisture content of about 22% to about 26% by weight and consists of:
a. the fruit or vegetable puree in an amount of about 22% to about 28% by weight of the batter;
b. the flour in an amount of about 25% to about 28% by weight of the batter;
c. the added sugar in an amount of about 22% to about 30% by weight of the batter;
d. the fat in an amount of about 10% to about 18% by weight of the batter;
e. the glycerin in an amount of about 3% to about 5% by weight of the batter;
f. the leavening base in an amount of about 0.05% to about 0.5% by weight of the batter;
g. an egg ingredient in an amount sufficient to provide a solids content of about 1% to about 5% by weight of the batter; and
h. other ingredients in a combined amount of up to 8% by weight of the batter.

8. The packaged, refrigerated composition of claim 1, comprising particulates distributed throughout the batter.

9. The packaged, refrigerated composition of claim 1, wherein the batter is packaged in a flexible plastic container.

10. The packaged, refrigerated composition of claim 9, wherein the flexible plastic container is a chub.

11. A method of making a packaged, refrigerated composition, comprising depositing a batter into a squeezable package, the batter having a moisture content of about 20% to about 28% by weight and a shelf life at 40° F. of about 90 to about 120 days, the batter including:
a. a fruit or vegetable puree in an amount of about 20% to about 30% by weight of the batter, the fruit or vegetable puree having a moisture content of about 70% to about 92% by weight of the puree;
b. a flour in an amount of about 25% to about 30% by weight of the batter;
c. added sugar in an amount of about 20% to about 30% by weight of the batter, the total sugar content in the batter being about 28% to about 32% by weight of the batter;
d. a fat in an amount of about 8% to about 20% by weight of the batter;
e. glycerin in an amount of about 2% to about 6% by weight of the batter; and
f. a leavening base in an amount of about 0.01% to about 2% by weight of the batter.

12. The method of claim 11, wherein the package comprises a plastic chub.

13. The method of claim 11, wherein the batter is deposited in the package within 4 hours of the batter being formed.

14. The method of claim 13, wherein the batter is deposited in the package within 1 hour of the batter being formed.
